(19) United States
(12) Patent Application Publication
(10) Pub. No.: US 2010/0067747 A1
(43) Pub. Date: Mar. 18, 2010

(54) METHOD AND DEVICE FOR RECOGNISING AN INDIVIDUAL

(75) Inventors: Francois Perruchot, Grenoble (FR); Andre Rouzaud, Seyssinet (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COMMISSARIAT A L'ENERGIE ATOMIQUE, Paris (FR)

(21) Appl. No.: 12/522,074

(22) PCT Filed: Jan. 3, 2008
(86) PCT No.: PCT/EP2008/050034

§ 371 Date: Jul. 2, 2009

(30) Foreign Application Priority Data
Jan. 5, 2007 (FR) 0752540

(51) Int. Cl. G06K 9/00; G06F 7/04

(52) U.S. Cl. 382/115; 340/5.82

(57) ABSTRACT

A device for recognizing an individual, including a sensor including a plurality of sensitive members having a contact area on which a portion likely to be that of the individual to be recognized is applied, a measurement mechanism connected to the sensitive members to supply information on local contact forces generated by the portion applied on the contact area, and a processor connected to the sensor to determine from the local contact forces a morphological characteristic of the individual to be recognized. The measurement mechanism also supplies information relating to at least another physical magnitude related to the contact, and the processor determines from the other physical magnitude a physiological characteristic of the individual to be recognized.

### TECHNICAL FIELD

The present invention relates to a method and device for recognition by biometric identification. The device is intended to be used in fields where a high level of security is sought in order to combat fraud attempts and where the certain identification of the individual is required. Among existing biometric recognition devices, the most widely used are fingerprint recognition devices because they are compact and cheap. But other devices exist such as, for example, devices for recognising the palm of the hand. The present invention is thus not limited to devices for recognising individuals from their fingerprints.

### STATE OF THE PRIOR ART

A device for recognising an individual from a fingerprint generally comprises a sensor with a plurality of sensitive members that make it possible to establish an image of the fingerprint of a finger posed on a contact area that is associated with the sensor.

The sensors may be for example optical sensors, capacitive sensors, thermal sensors, ultrasound sensors. Each sensitive member of the sensor then makes it possible to measure the local properties of light reflection, surface impedance, thermal conductivity or reflection of ultrasounds of a finger placed in contact. Reference may be made for example to document [1], the complete references of which are given at the end of the description and which reviews the different existing sensors.

Recently, sensors based on the measurement of the pressure generated by the epidermis have also been proposed. These are for example piezoelectric sensors or, with the development of MEM technologies (technologies using micro electro mechanics), contact sensors or capacitive measurement pressure sensors as described in document [2], the complete references of which are given at the end of the description. Each sensitive member of these sensors is sensitive to the local pressure generated by the finger in contact.

All of these sensors make it possible, from local measurements, to establish an image of the fingerprint by differentiating the ridges and valleys of the skin exposed facing the sensor. But known techniques of fingerprint capture do not make it possible to detect whether the finger is living. False fingers or decoys, in other words artificial fingers or dead fingers detached from their body, can deceive the sensor, the fraud being practically impossible to detect in so far as these false fingers have a plausible pattern of fingerprint.

Techniques have already been proposed to try to distinguish a false finger from a real living finger but they are not satisfactory for several reasons.

Document [3], the complete references of which are given at the end of the description, proposes using a fingerprint sensor and in addition, means of measuring physiological parameters such as for example the heart beat, the percentage of oxygenation of the blood, electrocardiographic signals, the spectral characteristics of human tissues, the blood flow, the hematocrit, the biochemical analysis of tissues, the electric plethysmography. The means of measuring physiological parameters is based on additional devices, not very practical to use, costly and bulky.

Document [4], the complete references of which are given at the end of the description, proposes using in addition to means of recognising a fingerprint optical means of detecting the blood flow, which make it possible to determine whether there is a fraud attempt or not. The means of detecting the blood flow are integrated in the sensor of the means of recognising the fingerprint. The cost of such a device is higher than that of a user who uniquely uses a sensor. In addition, said recognition device is not entirely satisfactory due to the reliability of the recognition. Indeed, it is possible to deceive the fingerprint recognition device by covering a real living finger with a fine membrane provided with an artificial fingerprint.

Indeed, this drawback exists in all recognition devices based on temperature, the percentage of oxygenation of the blood and, generally speaking, all of the physiological parameters based on measurements not directly linked to surface properties of the skin.

Document [5], the complete references of which are given at the end of the description, proposes a device that makes it possible to measure the transmission properties of the skin in the field of radiofrequencies. Once again this solution may be circumvented by using an artificial material imitating the transmission properties of the skin.

More recently, devices for recognising an individual by means of a fingerprint have been developed. They use the properties of transpiration of the skin. Reference may be made for example to documents [6] and [7], the complete references of which are given at the end of the description. In one embodiment, the sensor employed is of capacitive measurement surface impedance sensor type (also known as capacitive sensor). It has a contact face on which is applied the finger, which is rigid. The image of the fingerprint of a finger that transpires is different to that of a dry finger because sweat has a very high dielectric constant. The captured image of the fingerprint is all the darker at the ridges as the finger transpires. The sweat produced by the pores of these ridges diffuses along the ridges and gives a more intense image than that obtained in the absence of sweat. By capturing images of fingerprints of a same finger at different instants and by analysing their evolution over time, it is possible to determine whether the finger is a real living finger or a decoy. Indeed, a living finger is going to transpire over time and is going to give a more and more saturated image. The information on local impedance at the contact is employed both to obtain the fingerprint and the sudation characteristics.

In this method, firstly at least two finger images spaced over time are taken. From the final image, the lines materialising the summit of the ridges are determined. The final image taken makes it possible to determine these lines more easily because it is more saturated. These lines are used as analysis filter to transform an image of the fingerprint, which is two dimensional or 2D, in other words an image of a surface, into a one dimensional or 1D image, in other words an image of a line. This transformation makes it possible to obtain a series of criteria characteristic of the sudation phenomenon. One of these criteria is the presence of a characteristic frequency in the Fourier transform of the curve obtained, this spatial frequency being associated with the average distance between pores, which is typically around 0.5 millimetres. Another criterion is the evolution of the minima and maxima associated with this frequency stemming from the migration of sweat along these ridges. This other criterion thus characterises the diffusion of sweat along the ridge lines.

This method, which at first sight may seem promising, suffers nevertheless from several drawbacks. The information obtained from a unique measurement made by the surface impedance sensor characterises both the fingerprint and the sudation, which makes the interpretation difficult.

Such a method lacks reliability because the information characterising the sudation may be perturbed or even deceived by temporal modifications of the pressure generated by the finger on the sensor. Finally, processing cannot be carried out in real time because it is always the final image that is used to carry out the analysis.

### DESCRIPTION OF THE INVENTION

The aim of the present invention is to propose a device for recognising an individual that does not have the above limitations and difficulties.

One aim is in particular to propose a device for recognising an individual that is at the same time compact, inexpensive and capable of recognising the individual in a very reliable manner by determining whether an area exposed to the device and which should characterise the individual is really the area of the individual or a decoy.

Another aim of the invention is in particular to propose a device for recognising an individual that operates in real time.

Another aim of the invention is to propose a device for recognising an individual that operates with rapidity, while using very few points for the analysis.

To attain this aim, the present invention proposes a device for recognising an individual comprising a sensor comprising a plurality of sensitive members having a contact area on which a portion likely to be that of the individual to be recognised is to apply, measurement means connected to the sensitive members for supplying information relative to the local contact forces generated by the portion applied on the contact area and processing means connected to the sensor for determining from the local contact forces a morphological characteristic of the individual to be recognised. In this device, the measurement means also supply information relative to at least another physical magnitude related to the contact corresponding to the global pressure that is generated on the contact area or the local impedances at the contact area and in that the processing means determine from this other physical magnitude a physiological characteristic of the individual to be recognised.

Preferably, the morphological characteristic is the fingerprint of the individual.

The physiological characteristic may be the heart beat or a characterisation of the sudation.

The sensitive members each preferably comprise a flexible membrane, the deformation of which is measured by capacitive detection.

A sensitive member may comprise a pair of electrodes, used for the capacitive detection, one being fixed and the other being movable, integral with the flexible membrane.

One of the electrodes of the pair may be subdivided into two sub-electrodes, which makes it possible to measure the local impedance at the contact area with very good sensitivity. The sub-electrodes may be interdigitated.

A sensitive member may comprise one or several piezoresistive gauges.

A sensitive member may also comprise two electrodes integral with the flexible membrane.

According to a first embodiment, the measurement means may comprise:
a first conversion means connected by an electrical connection to the sensitive members and suited to supplying information relative to the local contact forces,
at least one second conversion means connected to the sensitive members either by means of said electrical connection or directly by another electrical connection and suited to supplying information relative to the other physical magnitude related to the contact.

According to a second embodiment, the measurement means may comprise:

multiplexing means connected to the sensitive members,

a first conversion means connected to the multiplexing means suited to supplying information relative to the local contact forces,

at least one second conversion means suited to supplying information relative to the other physical magnitude related to the contact, and

means of controlling the multiplexing means to connect the sensitive members to the first conversion means or to the second conversion means.

The second conversion means may be merged with the first conversion means.

In one embodiment, the first conversion means may comprise a converter for each sensitive member, suited to measuring a capacity variation due to the movement of the membrane.

When one of the electrodes is formed of two sub-electrodes, said sub-electrodes, connected together, are connected to the first conversion means.

When the other physical magnitude corresponds to the local impedances to the contact and the moving electrode is unitary, the second conversion means may comprise a converter for each sensitive member suited to measuring a variation in impedance between the moving electrode and earth.

When the other physical magnitude corresponds to the local impedances to the contact, and the moving electrode is subdivided into two sub-electrodes, the second conversion means may comprise a converter for each sensitive member suited to measuring a variation in impedance between the two sub-electrodes.

When the other physical magnitude corresponds to the local impedances to the contact and the electrodes of the pair are unitary, the second conversion means may comprise a converter cooperating with two neighbouring sensitive members suited to measuring a variation in impedance between the moving electrodes of the two neighbouring sensitive members.

When the other physical magnitude corresponds to the global pressure, the second conversion means may comprise a converter for all of the sensitive members or for a group of sensitive members, said converter being suited to measuring a global capacity variation due to the movement of the membrane corresponding to all of the sensitive members or to the group of sensitive members.

In an alternative, the first conversion means may comprise a converter for a group of sensitive members cooperating with a local multiplexer inserted between the group of sensitive members and the converter, said converter being suited to measuring a variation in capacity due to the movement of the membrane corresponding to each sensitive member of the group.

In an alternative, when the other physical magnitude corresponds to the local impedances to the contact, the second conversion means may comprise a converter for a group of sensitive members cooperating with a local multiplexer inserted between the group of sensitive members and the converter, said converter being suited to measuring a variation in impedance at each sensitive member of the group.

The second conversion means suited to measuring the local impedances to the contact may be merged with the first conversion means, which makes it possible to reduce both the costs and the volume.

The multiplexing means may comprise both interrupters and inverters.

The measurement of local forces makes it possible to establish a two dimensional mapping of local forces, this mapping may serve as measurement filter to select useful sensitive members to take into account for the measurement of the other physical magnitude. This makes it possible to increase the operating speed of the device for recognising an individual.

The present invention also relates to a method of recognising an individual by means of a sensor provided with a plurality of sensitive members cooperating with a contact area for a portion capable of being a portion of the individual to be recognised. It comprises the following steps:

measuring, by means of the plurality of sensitive members, the local contact forces generated during the contact with the portion to establish a two dimensional mapping of the local contact forces and use the mapping to determine an image of the portion of the individual to be recognised,

measuring, by means of the plurality of sensitive members, the local impedances to the contact generated during the contact with the portion to establish a mapping of the local impedances and using the mapping to determine the sudation characteristics of the portion in contact with the contact area,

and/or measuring, by means of the plurality of sensitive members, the integral of the local contact forces to obtain an integral of the pressure and using the integral of the pressure to determine a heart beat,

using the image of the portion to detect if it corresponds to that of the individual to be recognised,

using the sudation characteristics and/or the heart beat to detect if there is a fraud at the portion in contact.

The method may consist in using the sudation characteristics and/or the heart beat to confirm the identity of the individual determined from the image.

The method may consist in correcting the mapping of the local impedances to the contact by means of the two dimensional mapping of the local contact forces, particularly in the case where the sensor has an elastic surface.

The mapping of the local impedances may be a two dimensional mapping.

In the same way, the integral of the pressure may be a two dimensional integral.

To increase the processing speed in the method, it is possible to select by means of the two dimensional mapping the local contact forces of the useful sensitive members, which make it possible to determine the mapping of local impedances, this mapping being a one dimensional mapping.

With the same aim, it is possible to select by means of the two dimensional mapping the local contact forces of the useful sensitive members which make it possible to obtain the integral of the pressure, this integral being a one dimensional integral.

### BRIEF DESCRIPTION OF DRAWINGS

The present invention will be better understood on reading the description of embodiments, given purely by way of indication and in no way limiting, and by referring to the appended figures in which:

FIG. 1 shows a section of a device for recognising an individual according to the invention;

FIGS. 2A, 2B show in section and in top view an embodiment of a sensitive member of the sensor with which the device of the invention is provided;

FIGS. 3A, 3B show in section and in top view another embodiment of a sensitive member of the sensor with which the device of the invention is provided;

FIGS. 4A, 4B, 4C show three alternatives of the method for recognising an individual according to the invention;

FIGS. 5A to 5N show different connections between the sensitive members of the sensor and the conversion means depending on the type of measurement carried out;

FIG. 6 illustrates the interest of filtering with the mapping of the local contact forces the mapping of the local impedances and the integral of the pressure.

Identical, similar or equivalent parts of the different figures described hereafter bear the same number references so as to make it easier to go from one figure to the next.

In order to make the figures easier to read, the different parts represented in the figures are not necessarily to the same scale.

### DETAILED DESCRIPTION OF SPECIFIC EMBODIMENTS

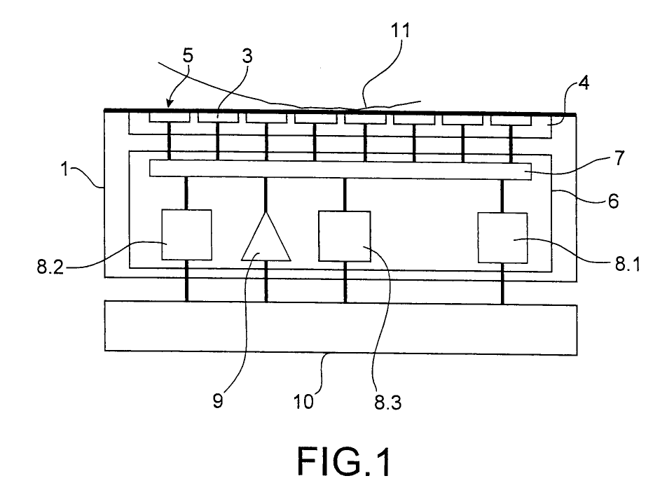

Reference will now be made to FIG. 1, which shows an example of a device for recognising an individual according to the invention. Said device comprises at least one sensor 1 comprising a plurality of sensitive members 3 at the contact arranged in a network 4 and contributing to delimiting an overlying contact area 5. These sensitive members 3 cooperate with measurement means 6 encompassing the multiplexing means 7, a first conversion means 8.1, at least one second conversion means 8.2, 8.3 and control means 9 of the multiplexing means 7. The multiplexing means 7 are connected firstly to the sensitive members 3 and secondly to the conversion means 8.1, 8.2, 8.3 and also obviously to the control means 9. Hereafter, the second conversion means, referenced 8.2, will be known as those corresponding to the measurement of the local impedance and the other second conversion means, referenced 8.3, those corresponding to the measurement of the global pressure. The second conversion means may be merged with the first conversion means 8.1. The other second conversion means 8.3 are optional but, if they are present, they are distinct from the first conversion means 8.1. The sensor 1 comprises at least two distinct acquisition modes. Thus, the sensor 1 is intended to measure at least two physical magnitudes linked to the contact, said contact being achieved by a portion 11 applied on the contact area 5. This portion 11 should be that of the individual to be recognised. The recognition device of the invention is going to be able to determine whether this portion 11 is a decoy or not and thus if there is a fraud or not. Decoy is taken to mean a dead area, for example a cut off finger, or an artificial area for example a finger casting, the surface of which imitates the pattern and the relief of the fingerprints. This portion 11 may be advantageously a finger but this is not limiting. It could be envisaged that it is the palm of the hand or other. In the following, it will be considered that it is a finger, without this obviously being limiting.

Among these two physical magnitudes, one of them corresponds to the local contact forces. Another physical magnitude corresponds to the local impedances to the contact or instead to the global pressure resulting from the contact. The term local signifies that the magnitude measured is acquired in a distinct manner for each sensitive member 3 of the sensor 1 or if necessary for a group of two neighbouring sensitive members. This term local is opposite to the term global, which indicates that the magnitude measured concerns the sensitive members taken together or in group.

The device according to the invention makes it possible to characterise simultaneously at least one physiological characteristic, such as sudation and/or the heart beat in addition to a morphological characteristic, such as the fingerprint of the individual to be recognised.

The measurement means 6 cooperate with processing means 10 connected to the sensor 1 intended to determine from measurements carried out by the measurement means 6 at least the morphological characteristic of the portion 11 applied on the contact area 5 and also a physiological characteristic of the individual. In the case where the portion 11 of the individual is a finger, the morphological characteristic is a fingerprint. In a more general case where another portion of skin is exposed, for example the palm of the hand, the characteristic is a fingerprint of the portion of the skin exposed. The physiological characteristic may be a characterisation of the sudation of the portion 11 of the individual exposed or instead the heart beat of the individual. These physiological characteristics make it possible to uncover frauds, when the area exposed to the device is a decoy instead of being a living area. The analysis of these physiological characteristics makes it possible to spot any decoys. The fact of having available two physiological characteristics makes it possible to further increase the reliability of the detection of any fraud but only one of the physiological characteristics may suffice in general. The processing means 10 are information processing algorithms which are well known for example as described in the document [6] for the characteristics of sudation.

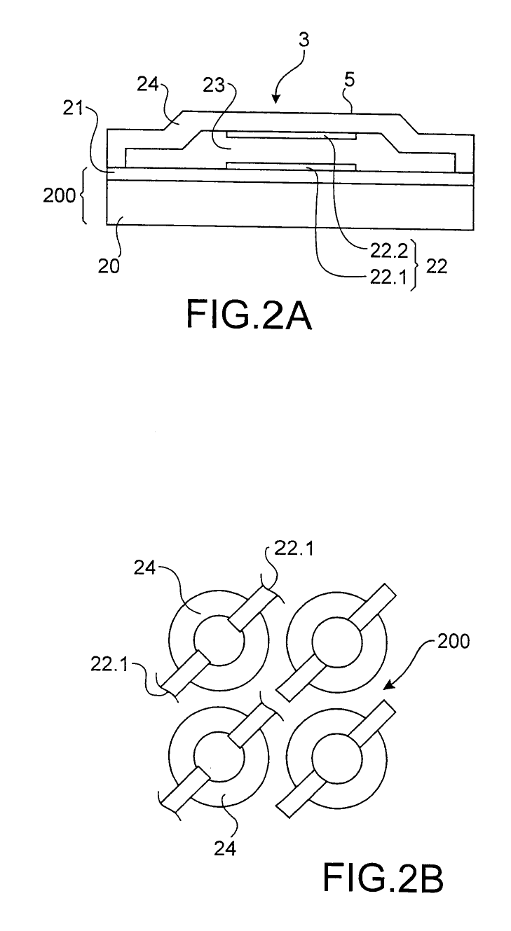

There is an advantage in using capacitive members as sensitive members. Reference is now made to FIGS. 2A, 2B, which illustrate a first embodiment of capacitive sensitive members. Obviously resistive instead of capacitive sensitive members could be used.

FIG. 2A shows in section several sensitive members 3 of a sensor 1 used in the device of the invention. FIG. 2B shows a bottom view of the sensitive members 3 of FIG. 2A. These members 3 may be of known flexible membrane type, formed using MEMS technology. All of the sensitive members 3 are integrated on a same electrically insulating base 200 formed for example of a semi-conductor substrate 20 such as silicon covered with an electrically insulating layer 21, for example made of silicon oxide. Each sensitive member 3 comprises a pair 22 of electrodes 22.1, 22.2 placed opposite each other, and separated by a space 23 of around 0.1 micrometre to 5 micrometres; a variation in the space 23 induces a voltage variation at the terminals of the electrodes of the pair, which indicates a variation in the capacity. One of the electrodes of the pair 22.1 is fixed and integral with the base 200 on the insulating layer side 21, the other electrode 22.2 of the pair is movable. Each sensitive member also has an electrically insulating flexible membrane 24, the edge of which is fixed to the base 200. The moving electrode 22.2 is integral with the flexible membrane 24. The membrane 24 delimits a cavity that encompasses at least partially the fixed electrode 22.1. A deformation of the flexible membrane 24, under the effect of a local contact force generated by the portion applied and which is assumed to be that of the individual that has to be recognised, generates this variation in the space 23. Preferably, the moving electrode 22.2 is fixed on the internal face of the flexible membrane 24 on the cavity side. It could be envisaged to place it on the external face of the flexible membrane 24, but it would then be necessary to add a protection to it so that the portion applied does not come into direct contact with it. In the configurations presented, it is the external face of the flexible membrane 24 that defines the contact area 5. FIG. 2A is a bottom view of the sensitive members 3 excluding the substrate. The flexible membrane 24 made for example out of Si₃N₄ will typically have a thickness of around a micrometre and will be sufficiently flexible to be sensitive to contact pressures of around several tens of kilo Pascals.

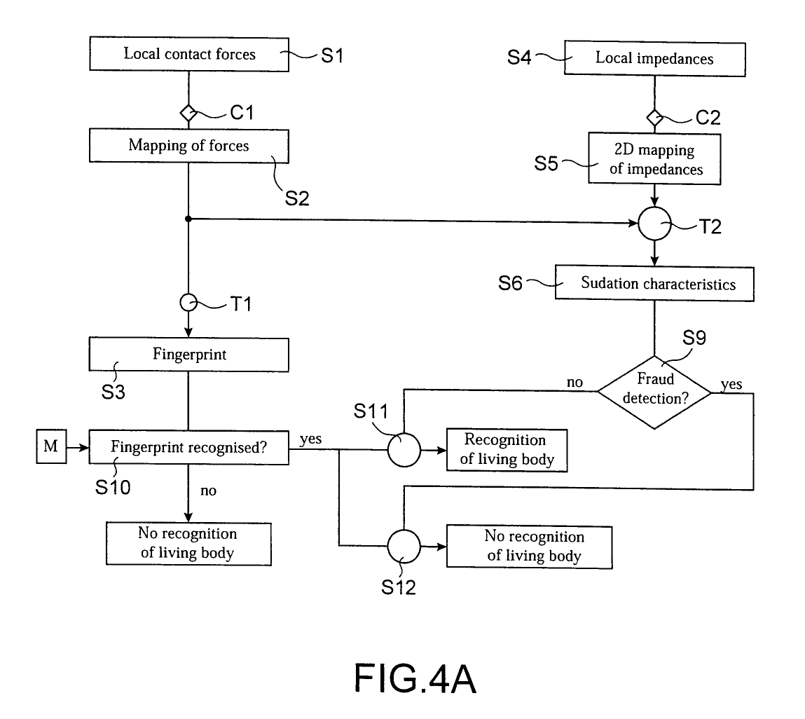

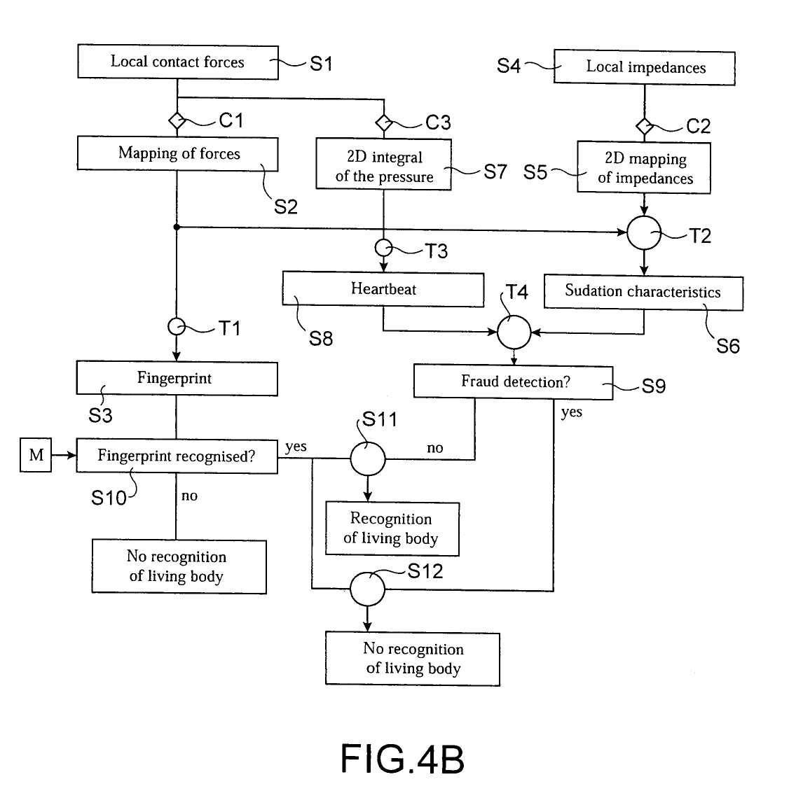

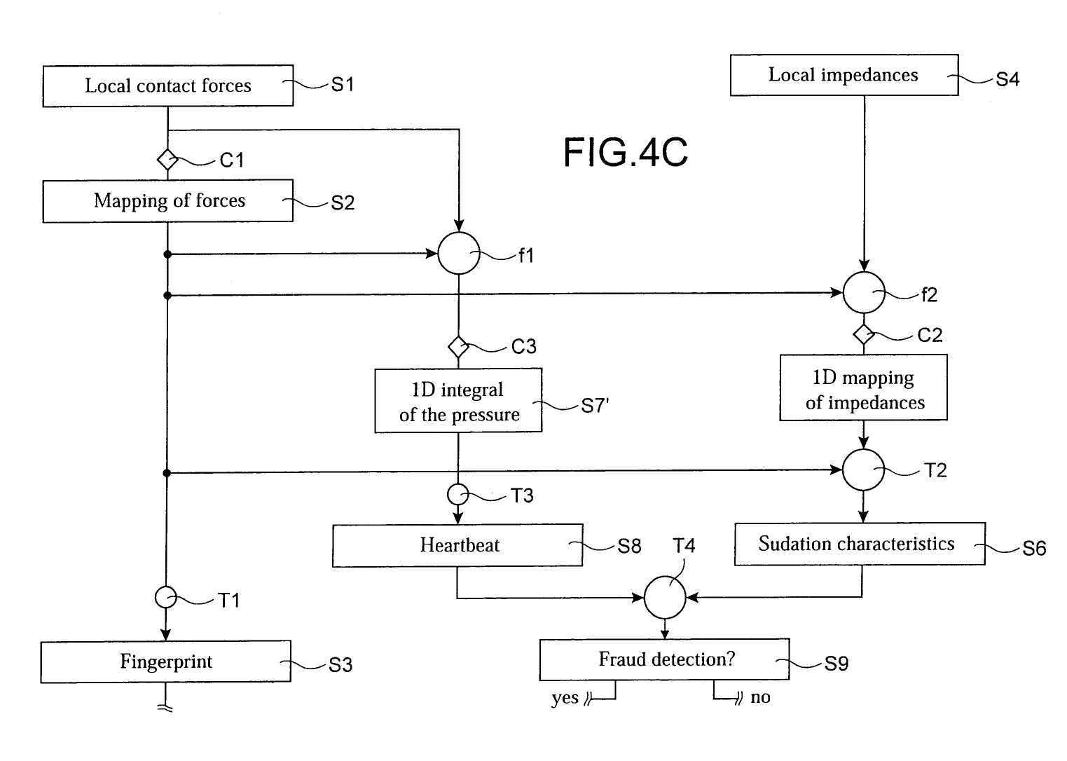

Each sensitive member 3 is connected by its electrodes 22.1, 22.2 to an electronic measuring device (not represented in FIG. 2 but visible in FIGS. 4 to 6) including the first conversion means 8.1, and the second conversion means 8.2, 8.3 and a portion of the multiplexing means 7. This electronic device is borne like all of the sensitive members by the base 200.

The sensor 1 may comprise all identical sensitive members 3 laid out in a matrix, each sensitive member 3 associated with its electronic measuring device occupying a surface area of around 50 micrometres by 50 micrometres. It is then possible to acquire an image of the portion 11 applied on the contact area 5 with a resolution of around 500 dpi (dots per inch).

The sensitive members 3 may be formed in a collective manner on the base 200, for example by methods compatible with those of forming CMOS type integrated circuits which are employed to make the electronic measuring device. Reference may be made for example to document [8], the complete references of which are given at the end of the description.

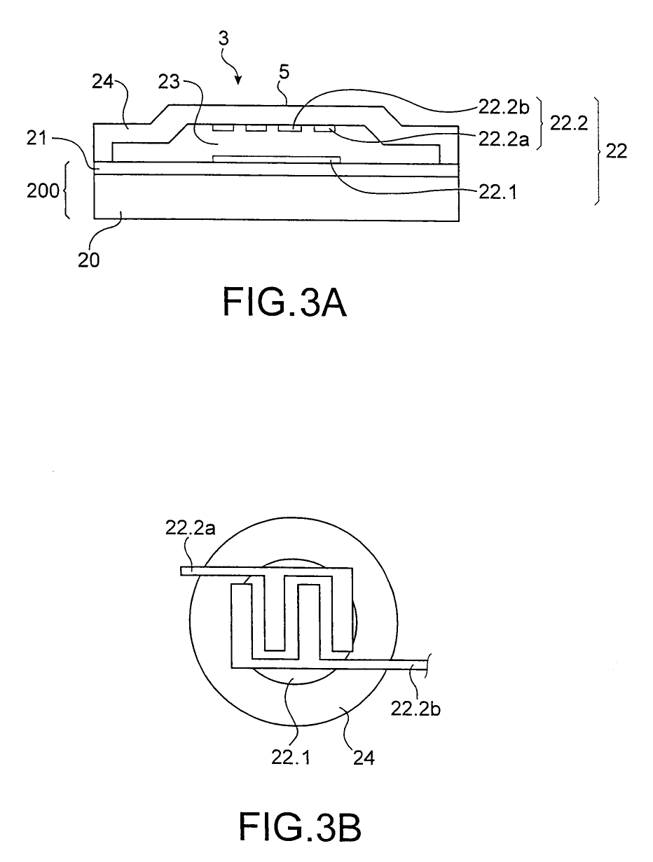

In an alternative illustrated in FIGS. 3A, 3B, it is possible to subdivide into two sub-electrodes 22.2a, 22.2b one of the electrodes 22.2 of a pair so as to be able to carry out easily a differential measurement of surface impedance.

Reference may be made to FIGS. 3A, 3B, which illustrate this second embodiment. The electrode subdivided 22.2 into two sub-electrodes 22.2a, 22.2b is the moving electrode.

The two sub-electrodes 22.2a, 22.2b may be interdigitated but other configurations are conceivable, for example as illustrated in document [9], the complete references of which are given at the end of the description.

A method for recognising an individual that implements the device that has just been described will now be described.

The acquisition of raw information by the sensor, its conversion and its processing make it possible to obtain firstly an image of the portion applied on the contact area of the device for recognising an individual and secondly an information on the occurrence or not of a fraud.

Reference may be made to FIG. 4A, which shows an example of a first embodiment of the method of the invention.

Raw information is acquired relative to the local contact forces that are generated by the portion placed in contact with the contact area of the device for recognising an individual on the sensitive members (block S1). These local contact forces depend on the topography of the skin of the portion of the individual to be recognised.

This raw information is easily accessible, it corresponds to a voltage value indicating a capacity value at each of the sensitive members of the sensor in so far as the sensor is a capacitive sensor. The capacity value may be measured in several ways.

This raw information relative to the local contact forces is converted (C1) in the first conversion means so as to establish a mapping of the local contact forces that apply on the sensor (block S2). It involves a two dimensional 2D mapping in which each sensitive member of the sensor or practically each sensitive member individually supplies information. Two dimensional mapping is taken to mean a mapping that is based on the information supplied by substantially all of the sensitive members 3 of the sensor 1. This two dimensional mapping of local contact forces is going to serve after processing (T1), in the processing means, to supply an image of the portion placed in contact and which should be that of the individual to be recognised, as it happens, in the example described of its fingerprint (block S3). The processing (T1) is conventional and is carried out by analysis of the ridges and valleys of the skin observed and by the determination of characteristic points of the fingerprint or minutiae, which are variations in the continuity of the ridges. The fingerprint that is then obtained in block S3 is independent of the local impedances and thus does not depend on the characteristics of sudation as was the case in documents [6] and [7].

This fingerprint indicates a morphological characteristic of the individual. This fingerprint could then be compared (block S10) to those of one or several individuals to be recognised that will have been stored beforehand in an appropriate memory M. The result of the comparison will make it possible to determine whether the individual is recognised or not. These fingerprints could have been memorised during an initialisation phase of the recognition device.

According to the method of the invention, with the same sensor 1 will also be carried out the detection of at least one physiological characteristic of the individual to check if the portion 11 that is exposed to the sensor 1 is really that of an individual, in other words if it is living.

This characteristic may be a characterisation of the sudation of the skin of the portion exposed to the sensor. This sudation characteristic cannot be obtained from raw information of local contact forces. The sudation appears at pores that are situated on the ridges of the portion of skin exposed to the sensor and then diffuse along these ridges.

Still with the same sensor 1, raw information is then acquired, which is the local impedance to the contact (block S4). With such a contact sensitive sensor, the two types of raw information may be obtained without spatial compromise. After conversion C2 in the second conversion means, the raw information of local impedances to the contact lead to establishing a two dimensional 2D mapping of the local impedances (block S5), the latter serving in a conventional manner after a processing T2, in the processing means, to determine the sudation characteristics (block S6) of the portion placed in contact. With these characteristics, it is possible to decide, by comparison, whether the sudation characteristics detected are the average characteristics of an individual or not and thus to detect a fraud (block S9).

If the sudation characteristics correspond to those of an individual, there is no fraud, in the opposite case there is fraud. In the absence of fraud and if the fingerprint detected corresponds to one of the memorised fingerprints, the individual is recognised and identified (block S11). In the presence of a fraud and if the fingerprint detected corresponds to one of the memorised fingerprints, the individual is not recognised (block S12).

It should be noted that the two dimensional mapping of impedances (block S5) is not necessarily independent of the mapping of the contact forces carried out in block S2. Indeed the local impedance measured by a sensitive member may be itself a function both of the surface in contact and the impedance of this surface. The surface in contact may itself be a function of the local force generated if the area in contact with the sensor is elastic. In this case, the sudation characteristics (block S6) will be obtained from the two dimensional mapping of the impedances corrected by the two dimensional mapping of the forces, for example by normalising the impedance by the contact force. This correction is indicated in FIG. 4 by the arrow directed from downstream of block S2 towards the processing T2.

Instead of carrying out a local measurement of impedance or in addition to this measurement, the method of the invention may provide to carry out a global pressure measurement generated on the contact area by the portion of the individual to be recognised. In this way, another physiological characteristic of the individual, which is his or her heart beat, is determined. Reference may be made to FIG. 4B in which two measurements are carried out leading to two physiological characteristics. Obviously it would have been possible to detect only the heart beat. This embodiment is similar to that illustrated in FIG. 4A for the detection of possible fraud once the information indicating the heart beat has been obtained and for this reason it is not illustrated alone. Obtaining the heart beat is described with reference to FIG. 4B.

This global pressure measurement is carried out by using as raw information the local contact forces acquired in block S1. This raw information is converted (C3) in another second conversion means so as to establish a two dimensional 2D integral of the pressure (block S7) that is generated on the sensor. The conversion C3 is an integration of the local contact forces. It takes account of the specificity of the information necessary to end up at the heart beat such as the temporal resolution or the width of the pass band. The heart beat (block S8) is determined from the two dimensional integral of the pressure after an appropriate processing T3, in the processing means, and more particularly a search and an analysis of the temporal variations in this integral of the pressure. This processing poses no problem to those skilled in the art. It is then possible to determine whether the temporal variations correspond or not to those of a real average heart beat of an individual.

In the same way as previously, if the heart beat is considered as real and if the fingerprint is known then the individual who has this fingerprint is recognised.

In the case where the two physiological characteristics are detected as in FIG. 4B, they may be combined (processing T4) to conclude in the occurrence of a fraud or not (block S9). If a fraud is detected, there is no recognition of the individual even if the fingerprint is known (block S12). If no fraud is detected and if the fingerprint is known (block S11), the individual having this fingerprint is then known. The sudation characteristics and the heart beat detected are then used to confirm the identity of the individual, the fingerprint of whom has been captured.

An increase in the rate of conducting the recognition method according to the invention, without reducing its reliability, may be obtained by proceeding as explained below while referring to FIG. 4C.

This improvement consists in using the two dimensional mapping of the contact forces (block S2) performed previously to determine which are the most significant sensitive members to take into account during the determination of the physiological characteristic(s). Indeed during the placing in contact of the portion on the sensor, only a fraction of the sensitive members supply useful information for the determination of a physiological characteristic. It involves sensitive members that detect the highest local forces. These sensitive members capture information relative to the ridge lines of the fingerprint. The valleys of the fingerprint lead to the lowest forces. The useful sensitive members are thus those that detect the ridge lines, the others may be ignored. The assumption is made that the sensitive members are not smaller than the distance separating two adjacent ridge lines. From the two dimensional mapping of the contact forces (block S2), the useful sensitive members that are going to be taken into account to determine the integral of the pressure (block S7′) and the mapping of impedances (block S5′) are thus selected. This integral and this mapping are known as one dimensional or 1D because they stem from signals supplied by sensitive members arranged substantially on one line (the ridge line) instead of sensitive members arranged along a surface. This selection corresponds to a filtering known as f1 when it leads to the one dimensional integral of the pressure (block S7′) and f2 when it leads to the one dimensional mapping of the impedances (block S5′). The one dimensional mapping of the impedance contains all the information necessary while being of size less than the two dimensional mapping of the impedance. It thus enables more rapid processing to end up with the sudation characteristics but there is no loss of information. The same is true for the integral of the pressure. If the portion applied is not a finger, it is also possible to select the useful sensitive members on which the pressure is high.

The remaining implementation of the method is similar to that described in FIG. 4B and so as not to make the description more unwieldy it is not repeated or fully drawn.

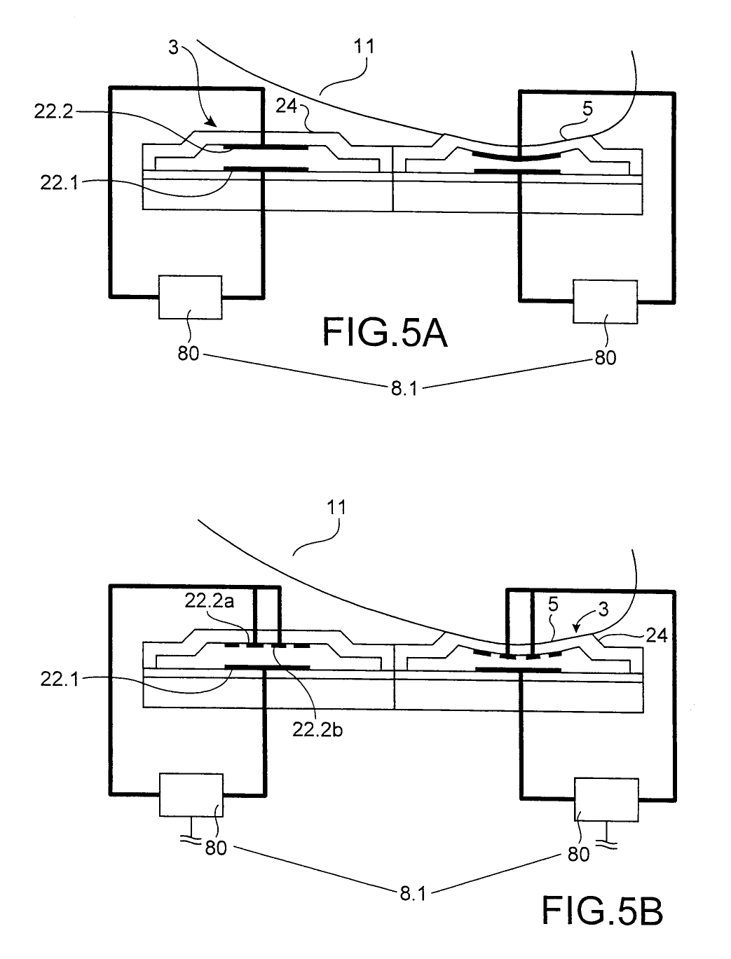

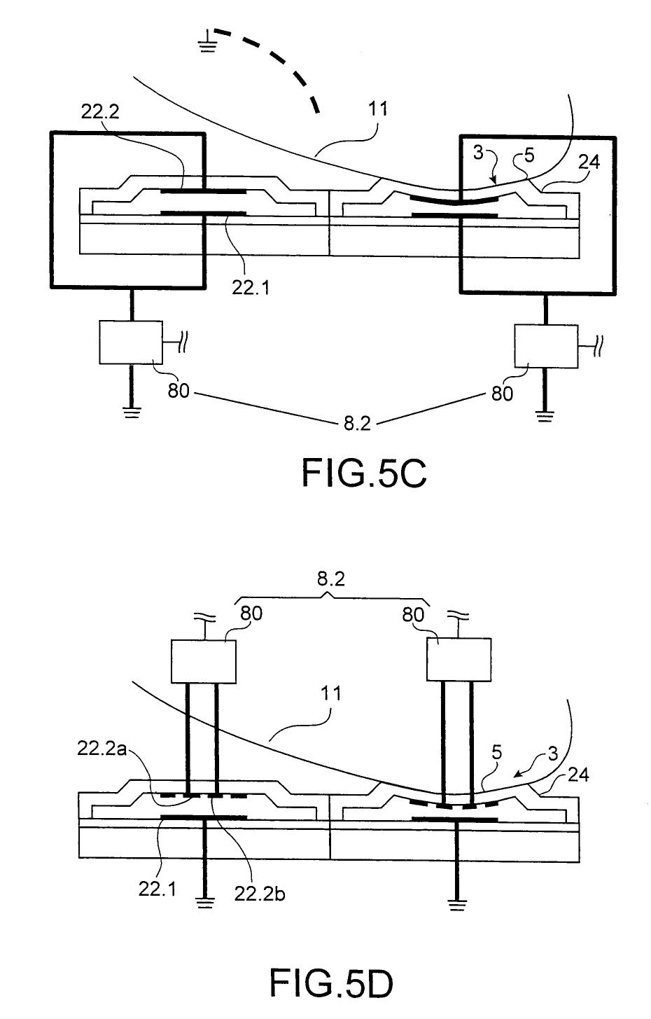

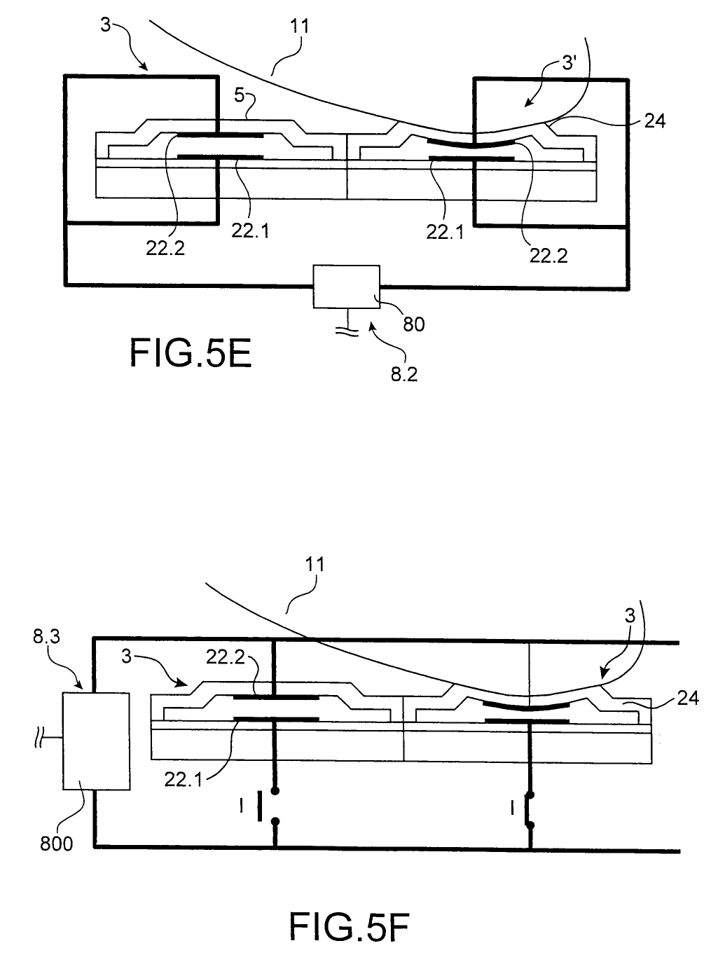

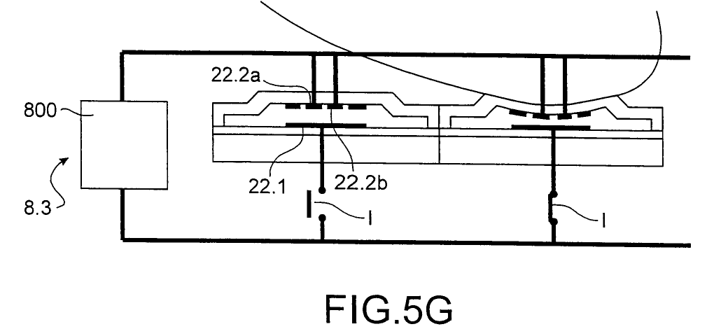

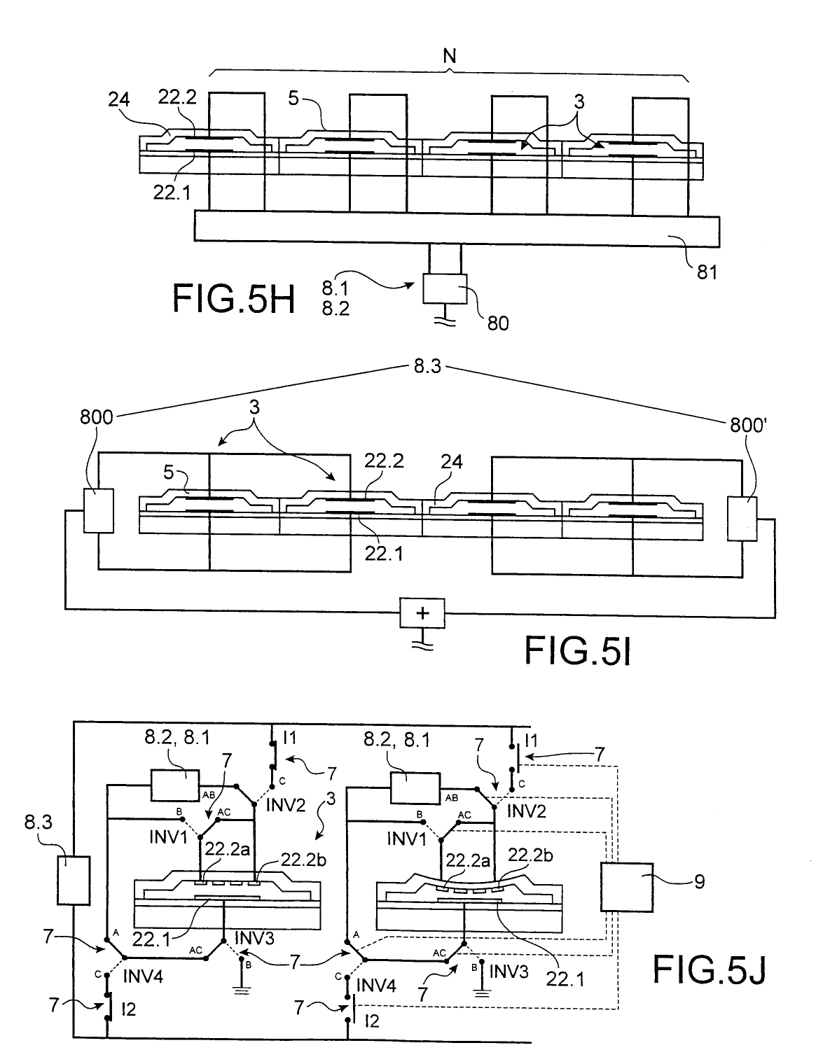

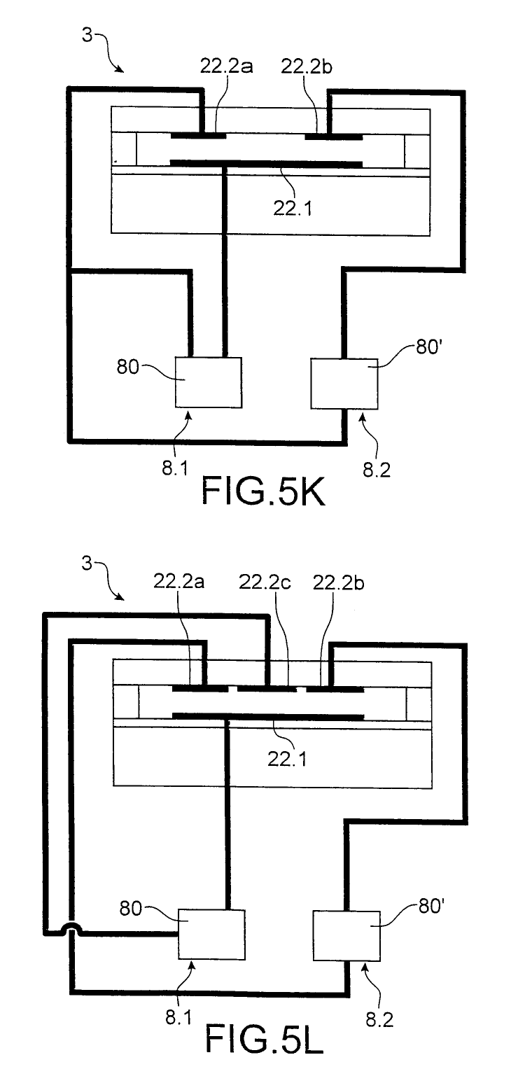

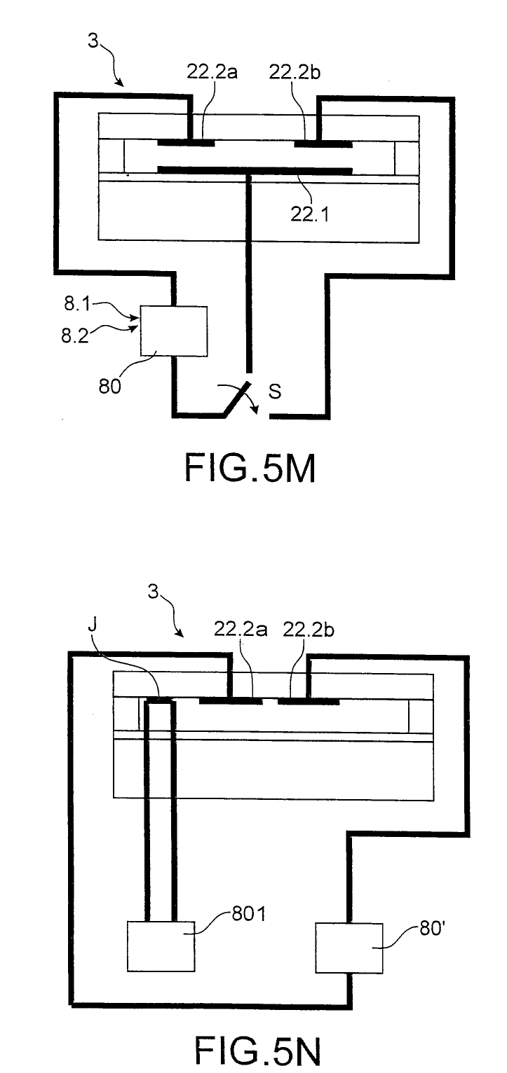

The different acquisition modes of the information supplied by the sensitive members 3 of the sensor 1 will now be described by referring to FIGS. 5A to 5J. FIGS. 5A, 5C, 5E, 5F, 5H, 5I, 5J concern sensitive members with a pair of unitary electrodes as illustrated in FIG. 2 and FIGS. 5B, 5D, 5G concern sensitive members in which one electrode of the pair is subdivided into two sub-electrodes as illustrated in FIG. 3.

In FIGS. 5A, 5B, the recognition device is in a mode wherein it acquires the raw information of local forces that is generated on the contact area 5 to establish the mapping of local forces. In this configuration, the first conversion means 8.1 are local, in other words each sensitive member 3 is connected to a converter 80 that is specific to it. More precisely, each converter 80 is connected in input firstly to an electrode 22.1 of the sensitive member 3 and secondly to the other electrode 22.2 of the sensitive member 3. The output of the converter 80 supplies the processing means (not represented). Each sensitive member 3 serves to carry out a local measurement of the capacity that is established between the two electrodes 22.1, 22.2 of the pair 22 of the sensitive member 3. Each converter 80 supplies information representative of the contact force generated at the associated sensitive member 3 and this information is going to form the mapping of the local contact forces. Each sensitive member 3 only detects the force generated by a portion of the part 11 that generates the contact, this portion being opposite the sensitive member 3. In FIG. 5A, the two sensitive members 3 do not detect the same force, since the portion 11 only presses on one of them and not on both. The collected information indeed depends on the local contact force and is independent of the surface impedance of the portion 11 that the contact generates.

In FIG. 5B, the only difference is that the two sub-electrodes 22.2a, 22.2b of the subdivided electrode 22.2 are connected together, which makes it possible to increase the sensitivity of the measurement. There is no modification to the first conversion means 8.1.

In FIGS. 5C, 5D and 5E, the recognition device is in a mode wherein it acquires the raw information of local impedances to establish the mapping of the local impedances. The second conversion means 8.2 are also local. They comprises a converter 80 associated with each sensitive member 3. In FIG. 5C, the two electrodes 22.1, 22.2 of the pair 22 of electrodes are connected together and in input of the associated converter 80. The portion 11 in contact is at the earth potential. The converter 80 is also connected in input to earth. Its output supplies the processing means (not represented). The measurement is a measurement of capacity compared to earth as disclosed in document [10], the complete references of which are given at the end of the description.

Thus, the variation in the capacity due to the movement of the flexible membrane 24 is not taken into account in the measurement of local impedances. In this configuration, whereas the sensitive member 3 comprises a pair of unitary electrodes 22.1, 22.2, it is necessary to provide both distinct first conversion means 8.1 and second conversion means 8.2, one for the measurement of local contact forces (FIG. 5A) and the other for the measurement of local impedances to the contact (FIG. 5C) because the measurement of the local contact forces is a differential measurement and the measurement of the local impedances to the contact is a measurement of impedance to earth.

When one of the electrodes 22.1 is subdivided into two sub-electrodes 22.1a, 22.1b as in FIG. 5D, still in the configuration for measuring local impedances, the two sub-electrodes 22.2a and 22.2b are each connected to a different input of the associated converter 80. The other electrode of the pair 22.1 is connected to a fixed potential for example earth. The output of the converter 80 is still connected to the processing means (not represented). In this configuration, it is possible to use merged first conversion means 8.1 and second conversion means 8.2, they serve both for the local measurement of local forces (FIG. 5B) and the local measurement of local impedances (FIG. 5D) because the two measurements are differential measurements. Only their connection to the electrodes differs and the multiplexing means make it possible to modify their connection.

The modes of FIGS. 5B and 5D are more interesting industrially than the mode of FIG. 5C.

It is also possible, when the sensitive member 3 only comprises a pair of unitary electrodes 22.1, 22.2 as illustrated in FIG. 5E, to measure the surface impedance between two neighbouring sensitive members 3 and 3′. The second conversion means 8.2 will then comprise a single converter 80 for the two neighbouring sensitive members 3 and 3′. The two electrodes 22.1, 22.2 of a sensitive member 3 connected together are connected to an input of the converter 80. The two electrodes 22.1, 22.2 of the other sensitive member 3′, connected together, are connected to the other input of the converter 80. The output of the converter 80 is connected to the processing means (not represented). In this configuration, the spatial resolution of the measurement is degraded but often this is not bothersome. It may however be considered that a local measurement is carried out. The advantage of this configuration is that the first conversion means and the second conversion means may be merged, they serve both for the local measurement of local forces (FIG. 5A) and the local measurement of the local impedances (FIG. 5E) because the two measurements are differential capacity measurements.

The converters 80 employed in the configurations that have just been described are local, they form part of the base cell as has been described in FIGS. 2 and 3 and/or are common to two sensitive members 3, 3′. They are situated very close to the electrodes 22.1, 22.2, generally below the pairs of electrodes as described in document [9]. The connection length between electrodes 22.1, 22.2 and converter 80 is thus very short, which enables low capacity variations to be measured. The resolution requirements are then limited, for example at the maximum 8 bits for a pass band of around several Hz. These converters may be successive approximation converters.

The measurement of the global pressure is illustrated in FIGS. 5F and 5G. The other second conversion means 8.3 relative to the measurement of the global pressure are here used. They are different to the first second conversion means 8.2 described previously. This other second conversion means 8.3 comprise a converter 800 associated with all the sensitive members 3 or with a group of several sensitive members 3. In the configuration of FIG. 5F, all of the pairs 22 of electrodes 22.1, 22.2 of the sensitive members 3 are connected in parallel and connected in input of a unique converter 800 forming the other second conversion means 8.3. This converter 800 is global for all of the sensitive members 3 of the sensor. The output of the converter 800 is to be connected to the processing means (not represented). In the configuration of FIG. 5G where one of the electrodes 22.2 is subdivided into two sub-electrodes 22.2a, 22.2b, the connection is similar but the two sub-electrodes 22.2a, 22.2b are connected together. The global converter 800 must make it possible to obtain a high resolution, typically greater than 14 bits for pass bands greater than 10 Hz. In this configuration, the size constraint is not critical since this unique converter 800 will adjoin the plurality of sensitive members 3. A sigma-delta converter well known in electronics could for example be used.

FIGS. 5F and 5G show interrupters I mounted between each same electrode 22.1 (fixed or moving) of a pair and the converter 800. These interrupters I form part of the multiplexing means 7, an additional description of these means will be made later. In this configuration, the interrupters I make it possible to carry out the one dimensional integral of the pressure since thereby a sensitive member 3 may be selected or instead ignored.

In an alternative as illustrated in FIG. 5H, it is possible that the first conversion means 8.1 or the second conversion means 8.2 comprise a converter 80 that cooperates with a group of N sensitive members 3. A local multiplexer 81 is inserted between this converter 80 and the sensitive members 3 that cooperates with it. This alternative makes it possible to increase the available surface for the converter 80 and the local multiplexer 81 by a factor N or to increase the density of the sensitive members 3.

It is possible that the other second conversion means 8.3 relative to the measurement of the global pressure incorporate several converters 800 to carry out the global measurement of the pressure, each of them cooperating with a group of sensitive members 3 only, the information supplied by these converters 800 then being added together. This alternative is illustrated in FIG. 5I, the adder being referenced by a +.

The interest of using the two dimensional mapping of the local forces to select the sensitive members 3 used to establish the one dimensional integral of the pressure may be illustrated here. For a step of 50 micrometres, the typical value of the capacity associated with a sensitive member 3 is around 15 fF. For a network of 100×100 sensitive members 3 the total capacity corresponding to the two dimensional integral of the pressure by using all of the sensitive members 3 is 150 pF. If only around 10% of sensitive members 3 are conserved during the selection to only conserve the most significant, a total capacity of around 15 pF is obtained but with a higher temporal variation.

The sensor that was shown in FIG. 5J has three distinct acquisition modes namely, mode A: local force measurement, mode B: local impedance measurement and mode C: global force measurement, making it possible to obtain the two dimensional mapping of local forces, the integral of the pressure and the mapping of local impedances from the same plurality of sensitive members. Going from one mode to the other takes place thanks to the multiplexing means 7 that modify the connections between the sensitive members 3 and the conversion means 8.1, 8.2, 8.3. In the example described, the first and second conversion means 8.1, 8.2 are merged. In the remainder of the description of FIG. 5J, only the first conversion means 8.1 will be described.

The multiplexing means 7 are formed, for each sensitive member 3 of a series of interrupters I1, and inverters INV1, INV2, INV3, INV4 making it possible to connect in a chosen manner each of the electrodes 22.1, 22.2 of the sensitive members 3 to the first and second conversion means 8.1, 8.2, 8.3 as a function of a chosen acquisition mode. The interrupters I1, I2 also make it possible to select the sensitive members to use for the measurements. During a local force measurement (mode A), the sensitive members called on, in other words the useful sensitive members, are determined. The global force measurement (mode C) may be made uniquely with the useful sensitive members.

The control means 9 are thus logic members making it possible to transform a set point corresponding to the acquisition mode A, B or C (local measurement of local forces, local measurement of local impedances, global measurement of the pressure) in a series of states for the interrupters I1, I2 and inverters INV1, INV2, INV3, INV4 of the multiplexing means 7.

One of the sub-electrodes 22.2a may be connected via the first inverter INV1 either to a first terminal of the first conversion means 8.1 (mode B), or to the other sub-electrode 22.2b (mode A and mode C). The other sub-electrode 22.2b may be connected via the second inverter INV2 either to the other terminal of the first conversion means 8.1 (mode A and mode B), or to a first terminal of the third conversion means 8.3 via a first interrupter I1 (mode C).

The fixed electrode 22.1 may be connected via the third inverter INV3 either to earth (mode B) or to the fourth inverter INV4 (mode A and mode C). The fourth inverter may thus connect the fixed electrode 22.1 firstly to the first terminal of the first conversion means 8.1 (mode A), or to the second terminal of the third conversion means 8.3 via the second interrupter 12 (mode C).

Thus in mode A, the two sub-electrodes 22.2a, 22.2b are connected together and to the second terminal of the first conversion means 8.1. The fixed electrode 22.1 is connected to the first terminal of the first conversion means 8.1 via the third inverter INV3 and the fourth inverter INV4.

In mode B, one of the sub-electrodes 22.2a is connected to the first terminal of the first conversion means 8.1. via the first inverter INV1 and the other 22.2b is connected to the second terminal of the first conversion means 8.1 via the second inverter INV2. The fixed electrode 22.1 is connected to earth via the third inverter INV3.

In mode C, the two sub-electrodes 22.2a, 22.2b are connected together and to the first terminal of the third conversion means 8.3 via the second inverter INV2. The fixed electrode 22.1 is connected to the second terminal of the third conversion means 8.3 via the third inverter INV3, the fourth inverter and the second interrupter 12.

In this representation, the interrupters making it possible to make the selection of the useful sensitive members that were illustrated in FIGS. 5F, 5G are not shown. The sensor thus has at least two distinct acquisition modes and if necessary three. The measurements may be sequential or simultaneous.

In FIGS. 5K to 5M will be described an embodiment of measurement means that are exempt of multiplexing means.

In these figures, only one sensitive member 3 of the sensor has been represented. Obviously, there are several and the conversion means may be connected to several sensitive members.

In FIG. 5K, there is a pair of electrodes formed of a common electrode 22.1 and facing each other two sub-electrodes 22.2a and 22.2b. Said sub-electrodes are integral with the membrane.

The measurement of force and the measurement of impedance are both based on a measurement of capacity. One of the two sub-electrodes 22.2a is common to the two measurements.

First conversion means 8.1 are provided, formed of a converter 80 electrically connected firstly to the common electrode 22.1 and secondly to one of the sub-electrodes 22.2a. These first conversion means 8.1 are suited to supplying information relative to the contact forces.

Second conversion means 8.2 are also provided, formed of a converter 80′, electrically connected firstly to one of the sub-electrodes 22.2a and secondly to the other sub-electrode 22.2b.

These second conversion means 8.2 are suited to supplying information relative to the other physical magnitude related to the contact, such as the local impedance. The measurements of forces and impedances may be simultaneous.

In FIG. 5L, instead of having two sub-electrodes there are three: 22.2a, 22.2b, 22.2c. They are integral with the membrane.

The first converter 80 is firstly electrically connected to the common electrode 22.1 and secondly to one of the sub-electrodes 22.2c. The second converter 80′ is electrically connected to the two other sub-electrodes 22.2a and 22.2b. The measurement principle is the same as in FIG. 5K.

In FIG. 5M is shown a common electrode 22.1 and two sub-electrodes 22.2a and 22.2b, a single converter 80 associated with a switch S making it possible to go from a force measurement to an impedance measurement depending on its position. In one position of the switch S, the converter 80 is electrically connected firstly to the common electrode 22.1 and secondly to one of the sub-electrodes 22.2a. In the other position of the switch S, the converter 80 is electrically connected firstly to one of the sub-electrodes 22.2a and secondly to the other sub-electrode 22.2b. The measurements of force and impedance cannot be simultaneous. The first conversion means 8.1 and the second conversion means 8.2 are merged and formed by the converter 80. The alternatives described in FIGS. 5K, 5L and 5M could be integrated in FIG. 5E in which the surface impedance is measured between several neighbouring sensitive members. A single converter is used for several sensitive members. It is also possible to use two different converters and to add interrupters in the multiplexer. This enables the sensitivity of the detection to be increased.

In FIG. 5N has been represented an alternative in which each sensitive member 3 comprises two sub-electrodes 22.2a, 22.2b but no common electrode. The two sub-electrodes 22.2a, 22.2b are integral with the membrane. These two sub-electrodes 22.2a, 22.2b are electrically connected to a converter 80′ which forms the second conversion means for the measurement of the impedance. The measurement of the impedance is still based on capacitive detection. The force measurement is based on a piezoresistive detection with at least one piezoresistive gauge.

In FIG. 5N, piezoresistive gauges J mounted in Wheatstone bridge cooperate with the membrane of the sensitive member 3. They detect the constraint induced by the deformation of the membrane. They are electrically connected to a first conversion means formed of a converter 801.

The piezoresistive gauges are provided in addition to electrodes.

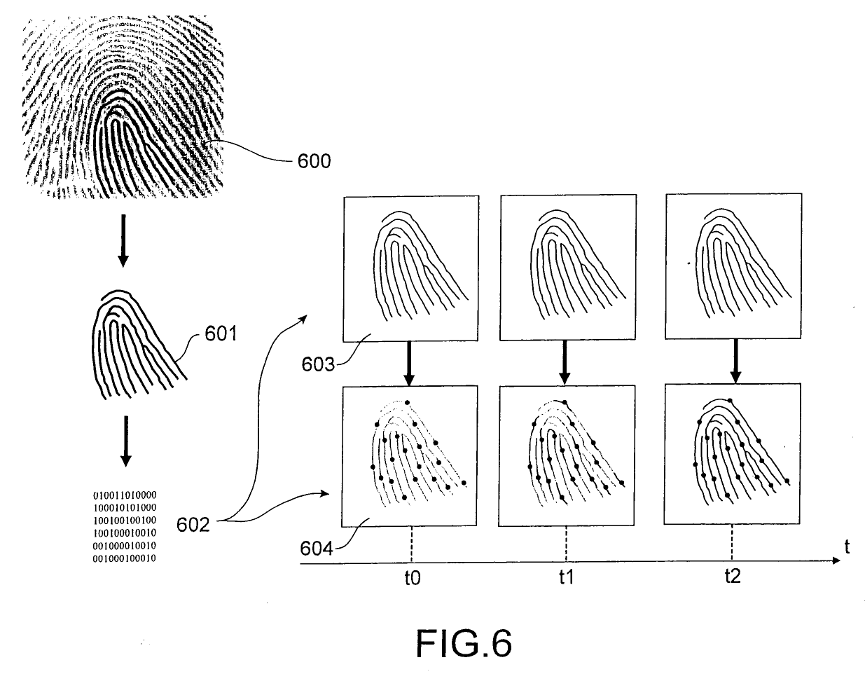

FIG. 6 illustrates a sequence of steps that make it possible to use an initial two dimensional mapping of local forces 600, to elaborate the one dimensional mapping of local impedances and the one dimensional mapping of forces. The ridge lines 601 extracted from the initial two dimensional mapping of the local forces 600, after digitisation, serve as measurement filter 602 to determine the useful sensitive members that will be used to elaborate the one dimensional mapping of forces on the one hand 603 and the one dimensional mapping of impedances 604. The three blocks in the one dimensional mapping of forces and in the one dimensional mapping of the impedance represent three successive temporal measurements, at the times t0, t1, t2 for example. It is possible to use the one dimensional mapping of forces 603 to correct the successive images of the one dimensional mapping of the impedance 604.

The device for recognising an individual according to the invention enables a reliable determination of the individual from the exposed portion such as his or her fingerprint in a manner independent of its sudation. Known devices that are based on the fingerprint and the sudation characteristics use sensors that supply information relative to the local impedances to the contact. But, it is necessary to have available sophisticated data processing means to separate the two items of information. These processing means are based on the hypotheses on the temporal variations of the two types of information such as for example that the fingerprint is constant over time and that the sudation characteristics change over time. By nature, these devices lack reliability.

Known devices for recognising individuals that use sensors supplying information relative to the local contact forces can only supply information on the fingerprint. The sudation characteristics cannot be obtained. Information on the heart beat is not accessible in a precise manner. These devices cannot have the function of detecting fraud as that of the invention.

The device according to the invention has advantages compared to the device described in document [7]. Indeed, the principle used in document [7] is based on both spatial and temporal image analysis. Two images are captured at an interval of five seconds. The first step serves to determine the ridge lines from the second image because it is more saturated than the first since the sudation has increased over time. In the present invention, the ridge lines may be determined as of the first image by using as raw data the local contact forces and not the local impedances to the contact.

In document [7], the ridge lines are used as analysis filter to transform a two dimensional image into a one dimensional curve and obtain a series of criteria characteristic of the phenomenon of sudation. This curve is only available at the end of the acquisition, which means that the processing cannot be carried out in real time.

In the device of the invention, the measurement filter 602 is available as of the first image acquired. The filtering is carried out in real time. The ridge lines may be used in subsequent image acquisitions 604 to select the sensitive members since only the information given by these sensitive members will be used for the analysis. This makes it possible to limit the number of sensitive members to take into account in an image and thus to use several images during a same processing time.

It is thus globally easy to monitor with a better temporal resolution the evolution of the sudation, which is a significant improvement for the implementation of processing algorithms as described in document [7].

In document [7], the information relative to the sudation may be perturbed or even deceived by varying over time the pressure of the finger on the sensor. In the present invention, the constant character of the pressure may be controlled by checking for example, at the end of processing, that the two dimensional mapping of the local forces has remained constant. If this is not the case, it is sufficient to follow over time the mapping of local forces 603 to adjust in real time the measuring filter. The final image acquired of the local contact forces is then used.

### REFERENCES CITED

[1] “Liveness Detection in Fingerprint Recognition Systems”, Chapter 4, pages 22-34, Thesis of Marie Sandström, 10 Jun. 2004, University of Linköping, Reg Nr: LITH-ISY-EX-3557-2004;
[2] FR-A-2 762 389;
[3] U.S. Pat. No. 5,719,950;
[4] U.S. Pat. No. 5,737,439;
[5] US-A-2003/0072475;
[6] WO-A-01/24700;
[7] “Determination of vitality from a non-invasive biomedical measurement for use in fingerprint scanners”, Reza Derakhshani et al., Pattern Recognition, vol. 36 (2003), pages 383-396;
[8] FR-A-2 762 389;
[9] EP-A-0 942 259;
[10] U.S. Pat. No. 4,353,056;

1-29. (canceled)

30. A device for recognizing an individual comprising:
a sensor comprising a plurality of sensitive members having a contact area on which a portion likely to be that of the individual to be recognized is to be applied;
measurement means connected to the sensitive members for supplying information relative to local contact forces generated by the portion applied on the contact area and for supplying information relative to at least another physical magnitude related to the contact corresponding to global pressure that is generated on the contact area or local impedances at the contact area; and
processing means connected to the sensor for determining from the local contact forces a morphological characteristic of the individual to be recognized and for determining from the another physical magnitude a physiological characteristic of the individual to be recognized.

31. A device according to claim 30, wherein the morphological characteristic is a fingerprint of a individual.

32. A device according to claim 30, wherein the physiological characteristic is a heart beat or a characterization of sudation.

33. A device according to claim 30, wherein each sensitive member comprises a flexible membrane, a deformation of which is measured by capacitive detection.

34. A device according to claim 33, wherein at least one of the sensitive members comprises a pair of electrodes used for the capacitive detection of the deformation, one being fixed and the other being movable, integral with the flexible membrane.

35. A device according to claim 34, wherein one of the electrodes of the pair is subdivided into two sub-electrodes.

36. A device according to claim 35, wherein the sub-electrodes are interdigitated.

37. A device according to claim 30, wherein at least one of the sensitive members comprises one or plural piezoresistive gauges.

38. A device according to claim 30, wherein at least one of the sensitive members comprises two electrodes integral with the flexible membrane.

39. A device according to claim 30, wherein the measurement means comprises:
first conversion means connected by an electrical connection to the sensitive members and configured to supply information relative to the local contact forces, and
at least one second conversion means connected to the sensitive members either by the electrical connection, or directly by another electrical connection, and configured to supply information relative to the other physical magnitude related to the contact.

40. A device according to claim 30, wherein the measurement means comprises:
multiplexing means connected to the sensitive members,
a first conversion means connected to the multiplexing means for supplying information relative to the local contact forces,
at least one second conversion means for supplying information relative to the another physical magnitude related to the contact, and
means for controlling the multiplexing means to connect the sensitive members to the first conversion means or to the second conversion means.

41. A device according to claim 40, wherein the first conversion means comprises a converter for each sensitive member, for measuring a capacity variation due to movement of the membrane.

42. A device according to claim 40, wherein the first conversion means comprises a converter for each sensitive member, for measuring a capacity variation due to movement of the membrane.

43. A device according to claim 40, wherein, the another physical magnitude corresponds to local impedances to the contact, and the moving electrode is unitary, and the second conversion means comprises a converter for each sensitive member for measuring a variation in impedance between the moving electrode and ground.

44. A device according to claim 39, wherein the another physical magnitude corresponds to local impedances to the contact, and the moving electrode is subdivided into two sub-electrodes, and the second conversion means comprises a converter for each sensitive member for measuring a variation in impedance between the two sub-electrodes.

45. A device according to claim 40, wherein the another physical magnitude corresponds to local impedances to the contact, and the moving electrode is subdivided into two sub-electrodes, and the second conversion means comprises a converter for each sensitive member for measuring a variation in impedance between the two sub-electrodes.

46. A device according to claim 40, wherein the another physical magnitude corresponds to local impedances to the contact, and the electrodes of the pair are unitary, and the second conversion means comprises a converter cooperating with two neighboring sensitive members for measuring a variation in impedance between the moving electrodes of the two neighboring sensitive members.

47. A device according to claim 40, wherein the another physical magnitude corresponds to global pressure, and the second conversion means comprises a converter for all of the sensitive members or for a group of sensitive members, the converter for measuring a global capacity variation due to movement of the membrane corresponding to all of the sensitive members or to the group of sensitive members.

48. A device according to claim 40, wherein one of the electrodes is formed of two sub-electrodes, and the sub-electrodes, connected together, are connected to the first conversion means.

49. A device according to claim 39, wherein the first conversion means comprises a converter for a group of sensitive members cooperating with a local multiplexer inserted between the group of sensitive members and the converter, the converter for measuring a capacity variation due to movement of the membrane corresponding to each sensitive member of the group.

50. A device according to claim 40, wherein the first conversion means comprises a converter for a group of sensitive members cooperating with a local multiplexer inserted between the group of sensitive members and the converter, the converter for measuring a capacity variation due to movement of the membrane corresponding to each sensitive member of the group.

51. A device according to claim 39, wherein the another physical magnitude corresponds to local impedances to the contact, and the second conversion means comprises a converter for a group of sensitive members cooperating with a local multiplexer inserted between the group of sensitive members and the converter, the converter for measuring a variation in impedance at each sensitive member of the group.

52. A device according to claim 40, wherein the another physical magnitude corresponds to local impedances to the contact, and the second conversion means comprises a converter for a group of sensitive members cooperating with a local multiplexer inserted between the group of sensitive members and the converter, the converter for measuring a variation in impedance at each sensitive member of the group.

53. A device according to claim 39, wherein the second conversion means is merged with the first conversion means.

54. A device according to claim 39, wherein the multiplexing means comprises interrupters and inverters.

55. A device according to claim 30, wherein the measurement of local forces makes it possible to establish a two dimensional mapping of the local forces, the mapping serving as a measurement filter to select useful sensitive members to take into account for the measurement of the another physical magnitude.

56. A method for recognizing an individual by a sensor including a plurality of sensitive members having a contact area for a portion capable of being a portion of the individual to be recognized, the method comprising:
measuring by a plurality of sensitive members local contact forces that are generated during contact with the portion, to establish a two dimensional mapping of local contact forces and using the mapping to determine an image of the portion of the individual to be recognized;
measuring by the plurality of sensitive members local impedances to the contact that are generated during the contact with the portion, to establish a mapping of the local impedances and using the mapping to determine the sudation characteristics of the portion in contact with the contact area;
and/or measuring by a plurality of sensitive members the integral of the local contact forces to obtain an integral of the pressure and using the integral of the pressure to determine a heart beat;
using the image of the portion to detect if it corresponds to that of the individual to be recognized; and
using sudation characteristics and/or heart beat to detect if there is fraud at the portion in contact.

57. A method according to claim 56, further comprising using the sudation characteristics and/or heart beat to confirm the identity of the individual determined from the image.

58. A method according to claim 56, further comprising correcting the mapping of the local impedances to the contact by the two dimensional mapping of the local contact forces.

59. A method according to claim 56, wherein the mapping of the local impedances is a two dimensional mapping.

60. A method according to claim 56, wherein the integral of the pressure is a two dimensional integral.

61. A method according to claim 56, further comprising selecting by the two dimensional mapping the local contact forces of the useful sensitive members that make it possible to determine the mapping of local impedances, this mapping being a one dimensional mapping.

62. A method according to claim 56, further comprising selecting by the two dimensional mapping the local contact forces of the useful sensitive members that make it possible to obtain the integral of the pressure, this integral being a one dimensional integral.
